(19) United States
(12) Patent Application Publication
(10) Pub. No.: US 2003/0117285 A1
(43) Pub. Date: Jun. 26, 2003

(54) Device indicating the fall of a body a water expanse

(76) Inventor: Jerome Bouillet, Portet sur Garonne (FR)

Correspondence Address: YOUNG & THOMPSON, 745 SOUTH 23RD STREET 2ND FLOOR, ARLINGTON, VA, 22202

(21) Appl. No.: 10/276,522

(22) PCT Filed: May 17, 2001
(86) PCT No.: PCT/FR01/01508

(30) Foreign Application Priority Data
May 17, 2000 (FR) 00/06282

(51) Int. Cl. G08B 23/00; G08B 21/08

(52) U.S. Cl. 340/573.6

(57) ABSTRACT

The invention concerns a device signalling the fall of a person into a water expense comprising a sealed hollow floatable housing (1), wherein is provided a motion sensor (2) adapted to produce a trigger signal when a movement is detected and an alarm signal transmitter (6) associated with the motion sensor (2) and capable of receiving from the latter the trigger signal and transmitting the alarm signal in response. The motion sensor (2) comprises a balance weight (2a) arranged elastically suspended in a tubular guide (2b) fixed to the housing (1), said balance weight (2a) mobile in said tubular guide (2b), in the lower part, being provided with at least a switch element (3) designed to be urged in contact with the balance weight (2a) by an ascending movement of the housing (1) and deliver through said contact the trigger signal.

The present invention concerns a device signalling the accidental fall of a person or animal into a water expanse, such as a swimming-pool, so as to avoid said person or animal drowning.

The prior art discloses various swimming monitoring devices able to detect the falling of a body and the accidental presence of a swimmer in the water expanse and to issue in return an alarm signal. Some of these devices are fixed in the swimming-pool, others are designed to be able to float and are provided with motion sensors able to react to the surface wave generated by the falling of a body. Thus, the document WO 9701858 discloses a monitoring device comprising a hollow body able to float and containing a detector comprising a heavy element worn by a flexible arm in a loop.

The drawback of these devices resides in the fact that they react to all types of stresses, especially those due to the current generated by the sucking up of water through the opening of the surface float skimmer, as well as those due to the impacts of cleaning devices against the body of the float.

These impacts may also be due to the sudden stoppage of the movement of the float against one of the surface walls and to any turbulence created by the partial obstruction of the opening of the surface float skimmer by the device. Thus, owing to ill-timed triggerings, the device is quite often disactivated and is unable to carry out its allotted role.

The object of the present invention is to resolve the above-mentioned problems by using a device which only reacts to vertical movements and not transversal movements.

To this effect, the device of the invention includes a sealed hollow housing able to float and containing firstly a motion sensor able to produce a trigger signal when a movement is detected, and secondly an element for transmitting an alarm signal associated with the motion sensor and able to receive from the motion sensor the trigger signal and in return transmit the alarm signal.

The device defined above is mainly characterised in that the motion sensor includes a balance weight arranged elastically suspended in a tubular guide fixed to the housing and extending upwards, said balance weight being able to move inside this tubular guide, and said guide, under the balance weight spaced from the latter, being provided with at least one switch element intended to come into contact with the balance weight via the ascending movement of the housing and via this contact deliver the trigger signal.

The tubular guide, in which the balance weight is mounted with play, prohibits any swinging movement of the balance weight on both sides of its longitudinal axis (axis of the guide), these swinging movements being due for example to the frontal impacts received by the housing and able to be at the origin of an ill-timed triggering of the alarm. On the other hand, the vertical movements of the water created by waves generated by the sudden introduction of a person or object into the water or created by the splashing movements of a person in distress in the swimming-pool shall be expressed by a relative movement of the balance weight in the tubular guide and once the latter is in contact with the switch element via the production of the alarm signal.

According to another characteristic of the invention, the housing, projecting under its lower face, comprises several stop elements intended to keep the body of the housing away from the suction opening by coming into support against the edge of said opening. These stop elements extend under the floating plane of the housing and are sufficiently long so as to come via their lower zone below the level according to which the lower edge of the surface float skimmer or any other suction opening extends, possibly contained in the swimming-pool on the surface. Thus, these stop elements arriving against the lower border of the suction opening prohibit the housing being introduced into the opening and forbid drawing off of the water in the pump.

Other advantages and characteristics of the invention shall appear on a reading of the description of a preferred embodiment with reference to the accompanying drawings on which:

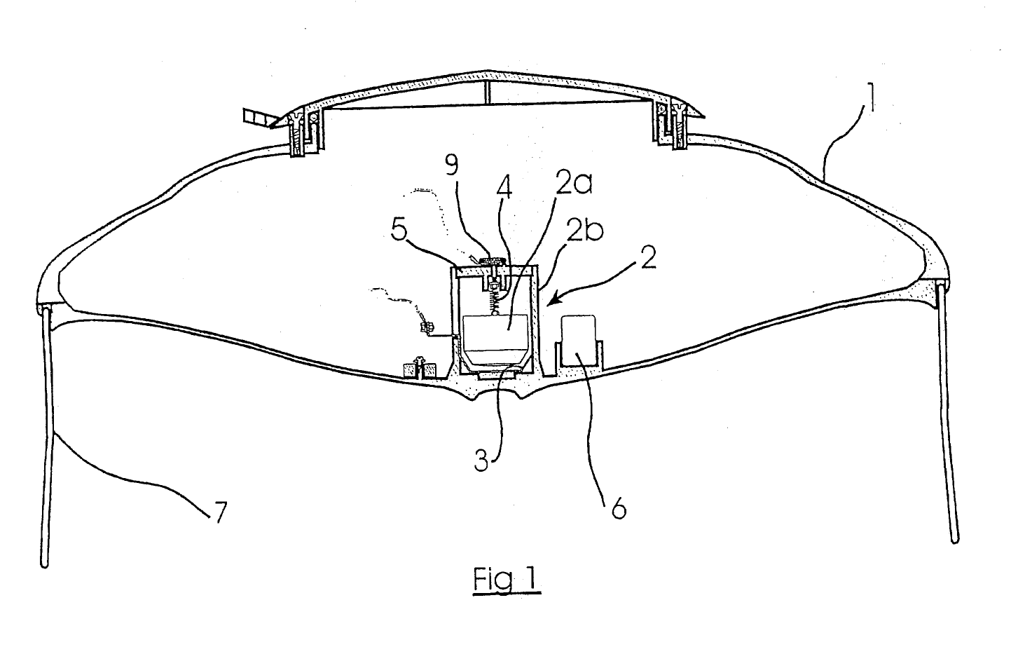

FIG. 1 is a cutaway view of the device of the invention,

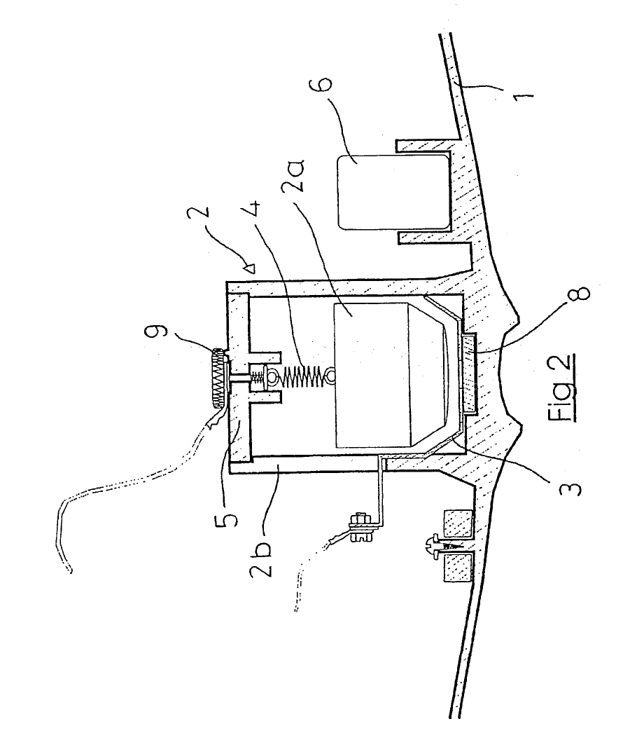

FIG. 2 is a cutaway view of details of the device of the invention,

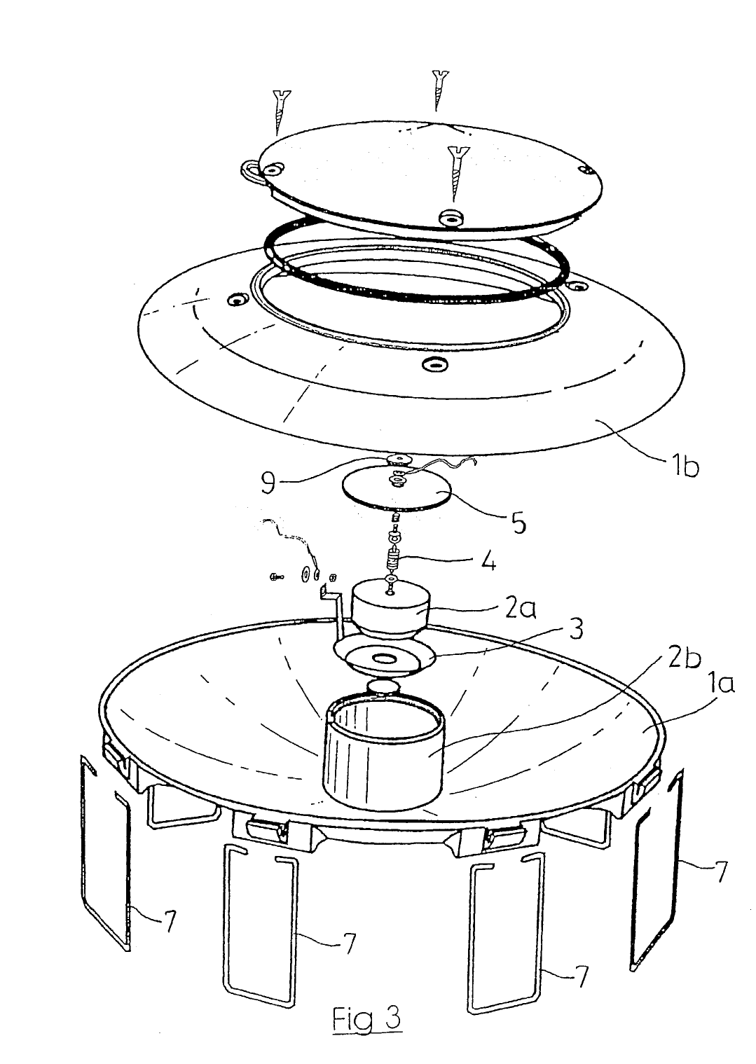

FIG. 3 is an exploded perspective view of the device of the invention.

As indicated, the device indicating the accidental fall of a person into a water expanse, such as a swimming-pool, comprises a sealed hollow floatable housing 1 and containing a motion sensor 2 able to produce a trigger signal when a movement is detected, and secondly a transmitter 6 for transmitting an alarm signal associated with the motion sensor 2 and able to receive the trigger signal from motion sensor 2, and transmit the alarm signal in response. According to one preferred embodiment, the alarm signal produced by the transmitter 6 is a radiofrequency signal. This radiofrequency signal is received by a radiofrequency receiver installed some distance away and able to produce in response on receiving the radiofrequency signal an audible sound signal of those persons assigned for monitoring of the swimming-pool.

The housing 1, preferably made of an antirot material, such as a synthetic material, includes a lower shell 1a and an upper shell 1b joined to each other according to a horizontal equatorial plane. Preferably, a sealing cord in the form of a sealing ring is inserted between the two shells. These shells are joined together by a set of linking screws.

In accordance with the invention, the motion sensor 2 includes a balance weight arranged 2a elastically suspended in a tubular guide 2b fixed to the housing. According to one first embodiment, this tubular guide is vertical. The balance weight is able to move inside the tubular guide 2b at least along the longitudinal axis of the latter, and this guide opposite the balance weight and spaced from said weight (when the latter is in an idle position), is equipped with a switch element 3 intended to come into contact with the balance weight 2a by an ascending movement of the housing and deliver through this contact the trigger signal. According to a first embodiment, the switch element is placed at the lower portion of the tubular guide.

Preferably, the balance weight 2a is suspended from a spring 4 itself suspended from a support element 5 fixed to the upper extremity of the tubular guide 2a. This support element can be a wall in the form of a disk able to seal off the upper portion of the tubular guide. Advantageously, this spring 4 is of the helical type with contiguous spires.

It is preferable that the longitudinal position of the balance weight in the sheath is adjustable. To this effect, the spring is fixed via its upper extremity to a vertical threaded spindle firstly engaged freely in a traversing perforation made in the support wall 5, and then by screwing into the internal screw thread of a knurled nut placed in support on the support wall. By means of this bias, it is possible to adjust the degree of driving in of the balance weight into the tubular element and thus the distance at rest between the balance weight and the switch element and accordingly the trigger threshold of the alarm. Thus, it is possible to discriminate the low amplitude movements, such as those caused by a slight wind, from greater amplitude movements, such as those brought about by the fall of a body. So as to further accentuate this discrimination, the tubular guide is slightly slanted with respect to vertical by several degrees. Owing to this arrangement, the balance weight in a stable position of the device on the water rubs against a slanted zone (or contact zone) of the housing defined by the tubular guide. The resultant friction forces oppose the movement of the balance weight in its guide as long as the device is in a stable position on the water or is animated by a slight oscillation movement, these oscillation movements being of insufficient amplitude to enable the balance weight to move away from the wall of the tubular guide. On the other hand, when the amplitude of the oscillation movement becomes more significant, the extend of the this amplitude can be representative of the fall of a body into the water expanse to be monitored, the balance weight being able to be freed from the wall of the tube and come into contact with the switch element 3.

According to the preferred embodiment, the balance weight 2a is electrically conductive and is electrically connected to one of the poles of an electric voltage source (not shown). The alarm signal transmitter 6 has a control input to which the trigger signal is to be applied so as to produce the alarm signal and the switch element 3 is an electric block electrically connected to the control input of the transmitter of the alarm signal. Thus, when the balance weight comes into contact with the block, an electric voltage is applied to the control input of the transmitter 6, this electric voltage being the trigger signal. It is to be noted that the disappearance of the trigger signal does not result in disappearance of the alarm signal, the trigger signal or alarm signal being stored.

Preferably, the balance weight 2a is connected to the pole of the electric voltage source by the elastic suspension, the latter being electrically conductive.

According to one first embodiment, the block 3 appears in the form of a disk and is fixed to the bottom of the tubular guide.

According to one advantageous embodiment, the disk 3 has a raised peripheral border delimiting a truncated volume and the balance weight has a lower truncated zone having a complementary profile. This arrangement makes it possible to ensure contact of the balance weight 2a with the block 3 in all cases and especially when the housing during its ascending movement finds itself slightly slanted with respect to horizontal. All other embodiments of the balance weight are possible. Thus, it is possible to provide a balance weight which is spherical, cylindrical or even having a truncated shape contrary to the one previously described and shown.

According to another embodiment, the switch element 3 is a push switch able to be activated by the balance weight 2a and electrically connected by one of its two electric contacts to the electric voltage source and by its other contact to the transmitter 6 of the alarm signal.

So as to firstly stabilise the balance weight 2a and for keeping the latter against the switch element 3 when contact with the latter is established, said balance weight 2a is made of a ferromagnetic material and is placed inside the magnetic field produced by a magnet 8 placed under the switch element 3 in the axis of the tubular guide 2b.

For a tubular guide slanted vertical, the switch element 3 can be placed, no longer at the lower portion of the tubular guide, but against the tubular wall of the guide in the latter so as to be diametrically opposite the contact zone of the balance weight with the guide so that the balance weight, when the device is in a stable position on the water or moves by a movement of slight amplitude, is distanced from the switch element. In this case, this switch element can appear in the form of a metal blade placed in the guide against the wall of the latter.

Preferably, the housing 1 projecting under its lower face comprises several stop elements 7 intended to keep the body of the housing away from the suction opening (for example the surface float skimmer) by coming into support against the border of said opening. The lower portion of each stop element is situated below the lower portion of the housing and the length of each element measured in a vertical direction is such that the lower portion of the element is still below the lower edge of the suction opening.

Moreover, each stop element, at least via its lower portion, projects with respect to the horizontal footing of the housing. Or, the stop elements 7 projected along a geometrical plane parallel to the equatorial plane of the housing, at least via their lower portion, are outside the surface delimited by the contour of the housing. In a variant, these stop elements are tangent to this contour and situated in the surface delimited by said contour. They may also stand slightly back with respect to this contour.

According to a first embodiment, the stop elements 7 are each fixed via their upper portion to the body of the housing and are each constituted by a longilinear element folded into a U. The upper portion of each branch of the U is bent at a right angle so as to be engaged in a mounting in a perforation made in the wall of the housing. A rear stop form of the body of the housing opposes folding back of the stop element under the body of the housing by being placed opposite at least one branch of the U.

As can be seen on FIG. 1, each stop element 7 by the geometrical plane it defines is perpendicular and intersecting one of the geometrical meridian planes of the housing.

According to another embodiment, the stop elements 7 are constituted by external radial wings regularly distributed and delimiting radial water expanse channels opening under the lower external central zone of the housing, said wings extending under the housing. Each wing has an external frontal edge. Preferably, this external frontal edge is perpendicular to the floating plane, but it can be slanted with respect to this plane.

Moreover, the lower portion of each wing is clearly situated below the lower portion of the housing and its length, measured in a vertical direction, is such that its lower portion is always below the lower edge of the opening of the surface float skimmer.

The distribution of the weights in the housing, the shape of the lower portion and that of the upper portion of said housing result in the housing occupying a particularly stable position when the lower portion is submerged, the centre of thrust being in this case mostly above the centre of gravity, and a particularly unstable position when the upper portion is submerged and located under the lower portion. In this reversing position, the centre of thrust is mostly located below the centre of gravity which generates a tilting torque by means of which the housing again takes up its normal use position.

The electric voltage source or energy source is integrated in the housing. This voltage source can be constituted by a set of rechargeable batteries or even by photoelectric cells. This voltage source feeds the transmitter 6 with electric energy. It is possible to place on the electric energy feed circuit a contactor ensuring the automatic opening of the circuit when the device is steeply inclined or reversed.

With this arrangement, each of the wings shall have an external frontal edge slanted vertically and progressively draw close to the vertical central axis of symmetry of the device from their upper zones towards their lower zones. At the level of this central axis, the various wings are able to join together or even be slightly spaced from one another. The lower portion of each wing can be pointed or rounded. The lower portions of the wings determine a support polygon with a small surface area which prohibits any stable position of the device when solely in support on said lower portions. Outside the water and in support on a horizontal plane, the stable position of the device can only be highly slanted. In this position, the device is in support on both the wings and on the upper portion of the lower shell.

According to one preferred embodiment, the contactor includes in a truncated housing sealed off by a movable stopper, two metal blades placed in series on the electric circuit and spaced from each other and forming a V in which a metal ball is placed ensuring in the use position of the device the electric conductivity between the two blades. Should the housing be steeply slanted, the ball is freed from one of the blades which opens the electric circuit. It is possible to use other types of contactors.

Finally, the central zone of the lower face of the housing has a cavity determining an irregularity in the convex profile with the lenticular shape of said internal face. Experience has shown that this cavity improves the stability of the housing on the surface wave.

The device of invention as described can freely move over the entire area of the basin. In one variant, the movement of the device is limited by a simple link, for example a wire made of a synthetic material, fixed firstly to a fastening point formed on the upper shell 1b of the housing, and secondly to a fastening point formed in the lip of the swimming-pool, for example.

It goes without saying that the present invention can accommodate all improvements and variants from a field relating to technical equivalents.

1. Device signalling the accidental fall of a person into a water expanse, such as a swimming-pool, comprising a sealed hollow housing (1) able to float containing firstly a motion sensor (2) able to produce a trigger signal when a movement is detected, and secondly a transmitter (6) for transmitting an alarm signal associated with the motion sensor (2) and able to receive from the motion sensor (6) the trigger signal and transmit in response the alarm signal, characterised in that the motion sensor (2) includes a balance weight (2a) placed elastically suspended in a tubular guide (2b) extending upwards and fixed to the housing (1), said balance weight (2a) being able to move inside this tubular guide (2b) and said guide (2b) under the balance weight (2a) spaced from the latter and being provided with at least one switch element (3) intended to come into contact with the balance weight (2a) via an ascending movement of the housing (1) and via this contact deliver the trigger signal.

2. Signalling device according to claim 1, characterised in that the balance weight (2a) is suspended from a spring (4).

3. Signalling device according to claim 1 or 2, characterised in that:
the balance weight (2a) is electrically conductive and is electrically connected to one of the poles of an electric voltage source,
the alarm signal transmitter (6) has a control input to which the trigger signal needs to be applied to produce the alarm signal,
the switch element (3) is an electric block electrically connected to the control input of the alarm signal transmitter (6).

4. Signalling device according to claim 3, characterised in that the balance weight (2a) is connected to the pole of the electric voltage source via an electric suspension (4) which is also electrically conductive.

5. Signalling device according to claim 3 or 4, characterised in that the electric block (3) appears in the form of a disk, this block being affixed against the bottom of the tubular guide (2b).

6. Signalling device according to claim 5, characterised in that the disk (3) has a raised peripheral border delimiting a truncated volume and in that the balance weight (2a) has a lower truncated zone.

7. Signalling device according to claim 1 or 2, characterised in that the switch element (3) is a thrust switch able to be activated by the balance weight (2a) and electrically connected by one of its contacts to an electric voltage source and by its other contact to the transmitter (6) of an alarm signal.

8. Signalling device according to one of the preceding claims, characterised in that the balance weight (2a) is made of a ferromagnetic material and is placed inside the magnetic field produced by a magnet (8) placed under the switch element (3) in the axis of the tubular guide (2b).

9. Signalling device according to one of the preceding claims, characterised in that the lower portion of the housing (1), at least below the floating plane, has a convex shape.

10. Signalling device according to one of the preceding claims, characterised in that the housing (1) projecting under its lower face comprises several stop elements (7) for keeping the body of the housing spaced from the suction opening by coming into support against the border of said opening.

11. Signalling device according to claim 10, characterised in that each stop element, at least via its lower portion, overlaps with respect to the horizontal spread of the housing.

12. Signalling device according to claim 10 or 11, characterised in that the stop elements are constituted by regularly distributed external radial wings delimiting water passage radial channels flowing under the lower external central zone of the housing, said wings extending under the housing (1).

13. Signalling device according to claim 12, characterised in that the external frontal edge of each wing is perpendicular to the floating plane.

14. Signalling device according to claim 10 or 11, characterised in that each stop element is constituted by a longilinear element folded into a U, the upper portion of each branch of the U being bent at a right angle so as to be engaged fixed in a perforation made in a projection of the housing

15. Signalling device according to claim 14, characterised in that each stop element via the geometrical plane it defines is perpendicular and intersecting one of the geometrical meridian planes of the housing.

16. Signalling device according to one of the preceding claims, characterised in that the central zone of the lower face of the housing has a cavity.

17. Signalling device according to one of claims 1 to 16, characterised in that the tubular guide is vertical.

18. Signalling device according to one of claims 1 to 16, characterised in that the tubular guide is slightly slanted with respect to vertical by several degrees so that the balance weight, in the stable position of the device on the water, rubs against a slanted zone (or contact zone) of the housing defined by the tubular guide, the resulting friction forces opposing the movement of the balance weight in its guide as long as the device is in a stable position on the water or is animated with a slight oscillation movement, these oscillation movements being of insufficient amplitude to allow the balance weight to deviate from the wall of the tubular guide, whereas when the amplitude of the oscillation movement becomes more significant, the extent of this amplitude able to be representative of the fall of a body into a water expanse to be monitored, the balance weight can then be freed from the wall of the tube and come into contact with the switch element 3.

19. Device according to claim 18, characterised in that the switch element (3) is placed against the tubular wall of the tubular guide in the latter and so as to be diametrically opposite the contact zone of the balance weight with the guide so that the balance weight, when the device is in a stable position on the water or is animated with a low amplitude movement, deviates from the switch element.
